(19) United States
(12) Patent Application Publication
(10) Pub. No.: US 2014/0035243 A1
(43) Pub. Date: Feb. 6, 2014

(54) APPARATUS FOR COUPLING A STIR STICK TO AN ELECTRIC DRILL

(71) Applicant: James Bruce Hoop, Tulsa, OK (US)

(72) Inventor: James Bruce Hoop, Tulsa, OK (US)

(21) Appl. No.: 13/562,909

(22) Filed: Jul. 31, 2012

(51) Int. Cl. B25F 3/00

(52) U.S. Cl. 279/145

(57) ABSTRACT

An apparatus for coupling a stir stick to an electric screwdriver or drill. The apparatus includes a clamp body and a drill boss. The clamp body applies opposing inward pressure against a side surface of the stir stick. The drill boss protrudes rearwardly from the clamp body, and rotates about an axis of rotation of the electric drill. Bilateral arms protrude forwardly from the clamp body, and one arm is disposed on each side of the axis of rotation. Each of the bilateral arms is sloped rearwardly toward the clamp body. Further, the bilateral arms may include one or more retaining elements that impinge into the stir stick when inward pressure is applied by the clamp body.

### BACKGROUND OF THE INVENTION

1. Field of the Invention

This invention relates to an apparatus coupling a stir stick to an electric drill, and more particular to an apparatus that supports a wooden stir stick and securely couples the stir stick to an electric drill for mixing a liquid coating composition.

2. Description of the Related Art

Liquid coating compositions, such as stains, sealants, varnishes, oil-based paints and latex-based paints, are typically sold in cans, buckets or other containers. Over time, the coating compositions tend to separate resulting in a thick sediment layer on the bottom or along the sides of the container and a thin liquid layer along the top of the coating composition in the container. As a result, the liquid coating composition must be mixed prior to being applied to a surface.

Mixing the liquid coating composition on site is typically achieved by using either a powered mixer or a wooden stir stick. Powered mixers typically include a drive unit having an attachment with radially projecting blades that mix the composition upon the blades being rotatably driven by the drive unit. Due to the expense of such attachments, the use is largely limited to professionals. “Do-it-yourselfers” typically utilize a conventional stir stick made of linear, elongate slabs or strips of wood having a length of about one (1) foot. These stir sticks, however, typically vary with respect to width and/or thickness. Mixing liquid coating compositions by hand with stir sticks is a tiresome, ineffective and inefficient process. As a result, the composition is not completely mixed, inhibiting complete coverage of the surface with the applied coating composition.

Apparatuses for coupling a wooden stir stick to an electric drill are known, but are inefficient in achieving a strong mechanical clamp between the apparatus and the stir stick. These apparatuses typically have a container or aperture into which the stir stick is slidably engaged. Because stir sticks typically vary in width and/or thickness, these containers or apertures do not always fully engage and/or secure the stir stick. This means of coupling the stir stick to the electric drill allows the stir stick to wobble during operation and does not allow for adjustment of the stir stick when coupled to the apparatus.

It is therefore desirable to provide an apparatus that supports a stir stick and securely couples the stir stick to an electric drill for efficient mixing of a liquid coating composition.

It is further desirable to provide an apparatus for coupling stir sticks having varying widths and thicknesses to an electric drill.

It is still further desirable to provide an apparatus for coupling a stir stick to an electric drill that allows for adjustment and/or centering of the center line of the stir stick to an axis of rotation of the drill.

### SUMMARY OF THE INVENTION

In general, in a first aspect, the invention relates to an apparatus for coupling a stir stick to an electric drill. The drill has an axis of rotation, and the apparatus includes a clamp body having a drill boss and bilateral arms. The drill boss protrudes away from the bilateral arms, while the bilateral arms generally slope from terminal ends toward the drill boss. The terminal ends of the bilateral arms have at least one retaining element. The apparatus also includes a means for applying opposing inward pressure against the stir stick.

The drill boss can be a hexagonal shank. The bilateral arms can include longitudinal, concave shoulder recesses, and/or can be tapered towards the axis of rotation from the terminal ends toward the drill boss. In this configuration, the clamp body near the drill boss has a width less than a width of the clamp body near the terminal ends of the bilateral arms.

The bilateral arms of the apparatus can further include an upper arm having an upper clamping surface, and a lower arm having a lower clamping surface opposing the upper clamping surface of the upper arm. A rear clamping surface is generally perpendicular to the upper clamping surface and the lower clamping surface. The upper clamping surface and the lower clamping surface can include opposing retaining elements.

The means for applying opposing inward pressure can be at least one fastener engaged with the terminal ends of the bilateral arms. Further, a plurality of apertures may be axially aligned in the terminal ends of the bilateral arms. The means for applying opposing inward pressure could also be a joint intermediate of the terminal ends of the bilateral arms.

In general, in a second aspect, the invention relates to an apparatus for coupling a stir stick to an electric drill. The stir stick has an edge surface and a side surface with a surface area substantially greater than a surface area of the edge surface. The apparatus includes a clamp body having an upper clamping surface and a lower clamping surface opposing the upper clamping surface. The clamp body further includes a rear clamping surface joined to and generally perpendicular with the upper clamping surface and the lower clamping surface. The apparatus also includes a drill boss forming an axis of rotation. A compressional fastener is joined to the clamping body and applies opposing inward pressure along the upper clamping surface and/or the lower clamping surface against the side surface of the stir stick.

Further, the clamp body can include sloped, bilateral arms disposed on opposing sides of the axis of rotation. The bilateral arms are an upper arm having the upper clamping surface and a lower arm having the lower clamping surface opposing the upper clamping surface of the upper arm. The upper arm and the lower arm terminate at the rear clamping surface. Moreover, the apparatus can include a first area of compression between the upper clamping surface of the upper arm and the lower clamping surface of the lower arm, and a second area of compression at the rear clamping surface. The upper clamping surface and the lower clamping surface may have opposing retaining elements. Additionally, the compressional fastener may be disposed within axially aligned apertures in a terminal end of the clamping body.

In general, in a third aspect, the invention relates to an apparatus for coupling a stir stick to an electric drill. The apparatus has a clamp body having bilateral arms and a drill boss opposing the bilateral arms. The bilateral arms have a plurality of clamping surfaces, with the clamping surfaces forming at least two areas for imparting clamping force against the stir stick. The areas are disposed in a spaced relation longitudinally along the clamp body. The drill boss constructed to be received within a drill chuck.

The bilateral arms may be sloped toward the drill chuck and include an upper arm having an upper clamping surface, and a lower arm having a lower clamping surface opposing the upper clamping surface of the upper arm. The upper arm and the lower arm terminate at a rear clamping surface. The apparatus also includes a compressional fastener joined to terminal ends of the bilateral arms for imparting opposing inward clamping force pressure along the upper clamping surface and/or the lower clamping surface.

### BRIEF DESCRIPTION OF THE DRAWINGS

FIG. 1 is a perspective view of an example of an apparatus coupling a stir stick in accordance with an illustrative embodiment of an invention claimed herein;

FIG. 2 is a top elevation view of the apparatus shown in FIG. 1;

FIG. 3 is a side elevation view of the apparatus shown in FIG. 1;

FIG. 4 is a bottom perspective view of the apparatus shown in FIG. 1 with the stir stick removed;

FIG. 5 is a cross-section view along line 5-5 of the apparatus shown in FIG. 2; and

FIG. 6 is a cross-section view along line 6-6 of the apparatus shown in FIG. 3.

Other advantages and features will be apparent from the following description, and from the claims.

### DETAILED DESCRIPTION OF THE INVENTION

The apparatuses and methods discussed herein are merely illustrative of specific manners in which to make and use this invention and are not to be interpreted as limiting in scope.

While the invention has been described with a certain degree of particularity, it is to be noted that many modifications may be made in the construction and the arrangement of the structural and function details disclosed herein without departing from the scope of the invention. It is understood that the invention is not limited to the embodiments set forth herein for purposes of exemplification.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “forwardly,” “horizontally,” “downwardly,” “upwardly,” etc.) should be construed to refer to the orientation as then described or as shown in the drawings under discussion. These relative terms are for convenience of description and do not require that the apparatus be constructed or the method to be operated in a particular orientation. Terms, such as “connected,” “connecting,” “attached,” “attaching,” “join” and “joining” are used interchangeably and refer to one structure or surface being secured to another structure or surface or integrally fabricated in one piece.

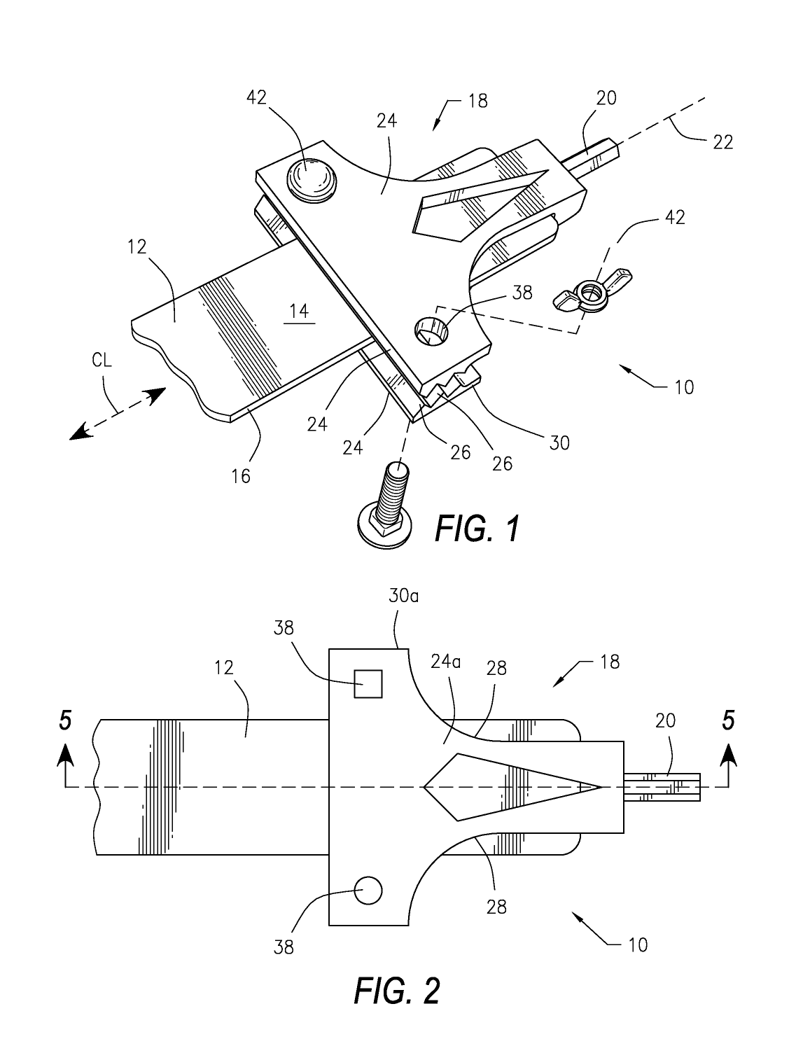

Referring to the figures of the drawings, wherein like numerals of reference designate like elements throughout the several views, and initially to FIG. 1, an apparatus 10 for coupling a stir stick 12 to an electric screwdriver or drill (not shown). The stir stick 12 has a side surface 14 and an edge surface 16. The side surface 14 has a surface area substantially greater than a surface area of the edge surface 16. The apparatus 10 includes a clamp body 18 having a drill boss 20. The clamp body 18 applies opposing inward pressure against the side surface 14 of the stir stick 12. The drill boss 20 is joined to the clamp body 18 and protrudes rearwardly therefrom. The drill boss 20 is constructed to be inserted into a chuck of the electric drill, such as depicted as a hexagonal shank. The drill boss 20 rotates about an axis of rotation 22 within the electric drill, and in order to prevent wobbling of the stir stick 12 during operation, a center line CL of the stir stick 12 should be aligned with the longitudinal axis of rotation 22 of the drill boss 20. The clamp body 18 of the apparatus 10 has a length that is generally parallel to the axis of rotation 22, and the length of the clamp body 18 is sufficiently sized to create leverage for supporting of the stir stick 12 and to prevent lateral movement of the stir stick 12 during use. The clamp body 18 of the apparatus 10 also has forwardly protruding, bilateral arms 24, with one disposed on each side of the axis of rotation 22. Each of the bilateral arms 24 is sloped toward an intersection with the axis of rotation 22 near the drill boss 20. Further, the bilateral arms 24 may include retaining elements 26 that are generally perpendicular to the axis of rotation and that impinge into the stir stick 12 when inward pressure is applied by the clamp body 18.

As shown in FIG. 2 from a top elevation, the clamp body 18 may be generally T-shaped in cross-section. The bilateral arms 24 may include longitudinal, concave shoulder recesses 28, or may be tapered inwardly from terminal ends 30 toward the axis of rotation 22. In this configuration, the clamp body 18 near the drill boss 20 has a width less than a width of the clamp body 18 at the terminal ends 30 of the bilateral arms 24.

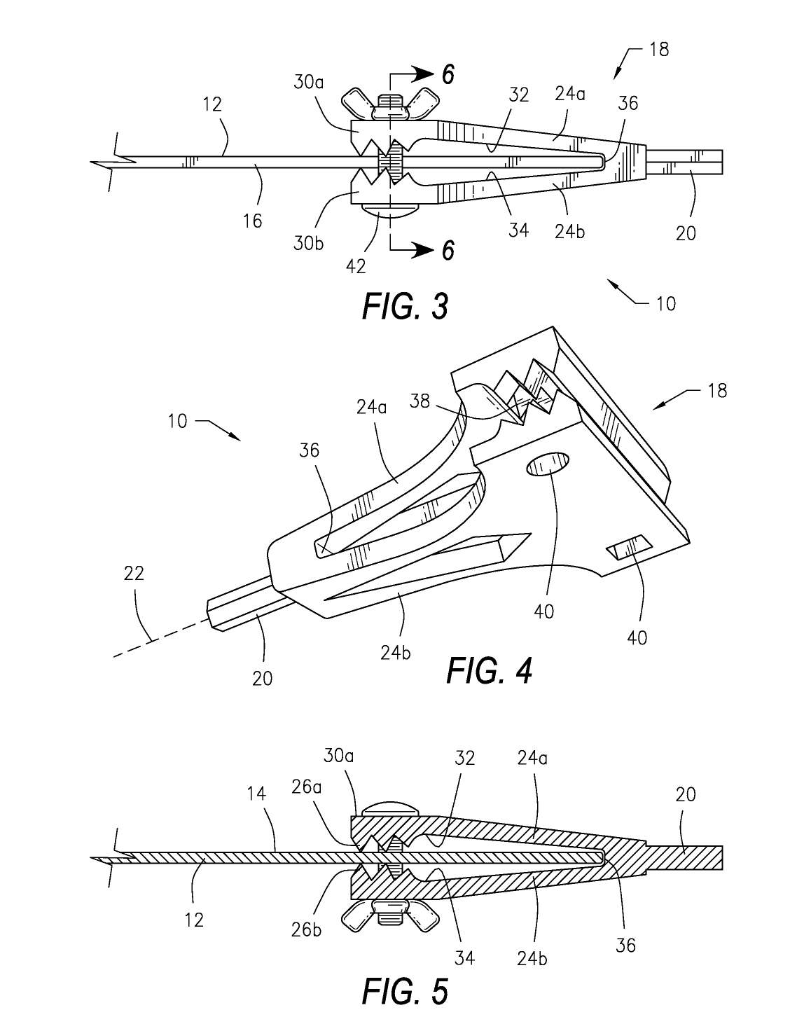

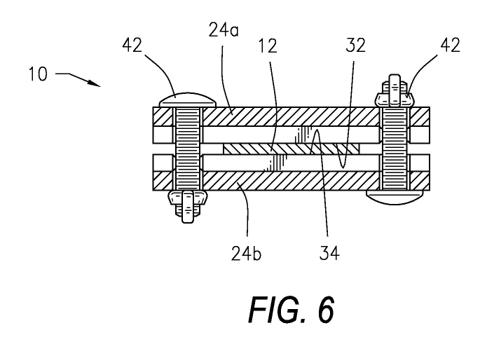

As shown in FIGS. 3 and 5 from a side elevation, the clamp body 18 is generally C-shaped in cross-section. In this orientation, the bilateral arms 24 comprise an upper arm 24a that forms an upper clamping surface 32 and a lower arm 24b that forms a lower clamping surface 34 opposing the upper clamping surface 32. The lower clamping surface 34 and the upper clamping surface 32 have opposing retaining elements 26, which form a first area 100 of a clamp force inward compression between the apparatus 10 and the stir stick 12. As depicted, the retaining elements 26 are opposing teeth 26a/b protruding generally perpendicular to the axis of rotation 22, and in this configuration, the apparatus 10 forms a jaw-like clamp body 18 having opposing teeth 26a/b protruding from the terminal ends 30 of the bilateral arms 24. A person having ordinary skill in the art will appreciate that the retaining elements 26 are not so limited and may be any protruding element that impinges into the stir stick 12, inhibits lateral and/or longitudinal movement of the stir stick 12, or otherwise forms one or more clamping points of contact between the apparatus 10 and the stir stick 12. The upper clamping surface 32 and lower clamping surface 34 terminate at a rear clamping surface 36 of the clamp body 18. The rear clamping face 36 is generally perpendicular to the axis of rotation 22, and forms a second area 200 of clamping force compression for controlling and securing the stir stick 12 to the apparatus 10.

In addition, the apparatus 10 includes a compressional means for applying opposing inward pressure along the clamp body 18 against the stir stick 12. The compressional means can be accomplished by joining the terminal ends 30 of the bilateral arms 24, with the side surface 14 of the stir stick 12 being engaged intermediate of the terminal ends 30. For purposes of exemplification, the terminal end 30a of the upper arm 24a includes spaced apertures 38 and the terminal end 30b of the lower arm 24b includes spaced apertures 40 axially aligned with the apertures 38 in the upper arm 24a. The internal diameters of the apertures 38 of the upper arm 24a and/or the internal diameters of the apertures 40 of the lower arm 24b may be threaded. A suitable fastener 42, such as a threaded bolt and a wing nut, a thumb screw or a protruding detent, may be inserted through the axially aligned apertures 38 and 40 and tightened to selectively apply opposing inward pressure along the side surface 14 of the stir stick 12. As exemplified in the drawings, the fastener 42 may be a carriage bolt, with one of the apertures 38 of the upper arm 24a having an annular cross-section and opposing one of the apertures 40 of the lower arm 24b, which may be square in cross-section. This orientation may then be reversed on the opposing ends of the upper arm 24a and the lower arm 24b, such that the fasteners 42 point in opposite directions, thereby balancing the weight of the fasteners 42 during rotation. A person having ordinary skill in the art will appreciate that other types of fasteners 42 or other compressional means for applying opposing inward pressure can be utilized in keeping with the scope of the invention. It will further be appreciated that the compressional means may be integrally fabricated into the apparatus 10.

Whereas, the apparatuses and methods have been described in relation to the drawings and claims, it should be understood that other and further modifications, apart from those shown or suggested herein, may be made within the scope of this invention.

What is claimed is:

1. An apparatus for coupling a stir stick to an electric drill, said drill having an axis of rotation, said apparatus comprising:
a clamp body having a drill boss and bilateral arms, said drill boss protruding away from said bilateral arms, said bilateral arms generally sloping from terminal ends toward said drill boss, and said terminal ends of said bilateral arms comprising at least one retaining element; and
a means for applying opposing inward pressure against said stir stick.

2. The apparatus of claim 1 wherein said drill boss is a hexagonal shank.

3. The apparatus of claim 1 wherein said bilateral arms include longitudinal, concave shoulder recesses.

4. The apparatus of claim 1 wherein said bilateral arms are tapered towards said axis of rotation from said terminal ends toward said drill boss.

5. The apparatus of claim 4 wherein said clamp body near said drill boss has a width less than a width of said clamp body near said terminal ends of said bilateral arms.

6. The apparatus of claim 1 wherein said bilateral arms further comprise:
an upper arm having an upper clamping surface;
a lower arm having a lower clamping surface opposing said upper clamping surface of said upper arm;
a rear clamping surface generally perpendicular to said upper clamping surface and said lower clamping surface.

7. The apparatus of claim 6 wherein said upper clamping surface and said lower clamping surface comprise opposing retaining elements.

8. The apparatus of claim 1 wherein said means for applying opposing inward pressure comprises at least one fastener engaged with said terminal ends of said bilateral arms.

9. The apparatus of claim 8 further comprising a plurality of aligned apertures in said terminal ends of said bilateral arms.

10. The apparatus of claim 1 wherein said means for applying opposing inward pressure comprises a joint intermediate of said terminal ends of said bilateral arms.

11. An apparatus for coupling a stir stick to an electric drill, said stir stick having an edge surface and a side surface with a surface area substantially greater than a surface area of said edge surface, said apparatus comprising:
a clamp body comprising an upper clamping surface and a lower clamping surface opposing said upper clamping surface, said clamp body further comprising a rear clamping surface joined to and generally perpendicular with said upper clamping surface and said lower clamping surface;
a drill boss forming an axis of rotation; and
a compressional fastener joined to said clamp body for applying opposing inward pressure along said upper clamping surface and/or said lower clamping surface against said side surface of said stir stick.

12. The apparatus of claim 11 wherein said drill boss is a hexagonal shank.

13. The apparatus of claim 11 wherein said clamp body further comprises sloped, bilateral arms disposed on opposing sides of said axis of rotation.

14. The apparatus of claim 13 wherein said bilateral arms further comprise:
an upper arm having said upper clamping surface;
a lower arm having said lower clamping surface opposing said upper clamping surface of said upper arm; and
said upper arm and said lower arm terminating at said rear clamping surface.

15. The apparatus of claim 14 further comprising:
a first area of compression between said upper clamping surface of said upper arm and said lower clamping surface of said lower arm; and
a second area of compression at said rear clamping surface.

16. The apparatus of claim 11 wherein said upper clamping surface and said lower clamping surface comprise opposing retaining elements.

17. The apparatus of claim 11 wherein said compressional fastener is disposed within axially aligned apertures in a terminal end of said clamping body.

18. An apparatus for coupling a stir stick to an electric drill, comprising:
a clamp body comprising bilateral arms and a drill boss opposing said bilateral arms, said bilateral arms comprising a plurality of clamping surfaces, said clamping surfaces forming at least two areas for imparting clamping force against said stir stick, said areas disposed in a spaced relation longitudinally along said clamp body, and said drill boss constructed to be received within a drill chuck.

19. The apparatus of claim 18 wherein said bilateral arms are sloped toward said drill chuck and further comprise:
an upper arm having an upper clamping surface;
a lower arm having a lower clamping surface opposing said upper clamping surface of said upper arm; and
said upper arm and said lower arm terminating at a rear clamping surface.

20. The apparatus of claim 19 further comprising a compressional fastener joined to terminal ends of said bilateral arms for imparting opposing inward clamping force pressure along said upper clamping surface and/or said lower clamping surface.
